(19) United States
(12) Patent Application Publication
(10) Pub. No.: US 2024/0322450 A1
(43) Pub. Date: Sep. 26, 2024

(54) PATCH ANTENNA ARRAY AND METHOD FOR MANUFACTURING A PATCH ANTENNA ARRAY

(71) Applicant: u-blox AG, Thalwil (CH)

(72) Inventors: Ioannis Gouzouasis, Marousi (GR); Matthias Mahlig, Berlin (DE); Peter Karlsson, Malmö (SE)

(21) Appl. No.: 18/602,529

(22) Filed: Mar. 12, 2024

(30) Foreign Application Priority Data
Mar. 23, 2023 (EP) 23163659.8

(51) Int. Cl. H01Q 21/06; H01Q 9/04; H01Q 21/00

(52) U.S. Cl. CPC H01Q 21/065; H01Q 9/0414; H01Q 21/0087

(57) ABSTRACT

The present disclosure describes a patch antenna array including a substrate, a ground plane arranged on a first surface of the substrate, and a plurality of patch elements arranged in proximity to each other on an opposite, second surface of the substrate. At least one of the plurality of patch elements has a rectangular shape having a width and height, the height being different from the width. At least two of the plurality of patch elements differ with respect to at least one of their respective widths and height, and each patch element of the plurality of patch elements is configured with a common resonance frequency. The present disclosure further describes a method for manufacturing a patch antenna array.

The present invention relates to a patch antenna array comprising a substrate, a ground plane, and a plurality of patch elements. The present invention further relates to a method for manufacturing such a patch antenna array.

Patch antennas are widely used in various fields of electronic communication. They can be manufactured relatively easily, for example using conventional printed circuit board (PCB) techniques, by arranging a number of electrically conductive patch elements on an insulating substrate, such as a PCB. In this case, control electronic as well as the antenna of a transmitter circuit can be arranged on a common PCB. Nonetheless, due to their advantageous transmission characteristic and simple design, patch antennas are also used as separate antenna elements, for example using ceramic carrier substrates. More recently, multiple patch elements are often combined in a one or two-dimensional arrangement for specific applications. For example, by arranging a plurality of similar patch elements in a row, angle of arrival (AoA) estimations for an incoming radio frequency (RF) signal can be performed. As another example, by controlling the relative phase angles and relative amplitude of signals provided to individual patch elements, beam forming can be performed. Moreover, a plurality of patch elements may also be exploited for high data rate communications using antenna diversity transmission or spatial multiplexing.

However, in the case that multiple patch elements are arranged on a common substrate and/or share a common ground plane, the individual patch elements interfere with each other, which is undesirable. Accordingly, it is an object of the present disclosure to provide improved patch antenna arrays and methods for their manufacturing.

According to a first aspect of the present disclosure, a patch antenna array is provided. The patch antenna array comprises a substrate, a ground plane arranged on a first surface of the substrate, and a plurality of patch elements arranged in proximity to each other on an opposite, second surface of the substrate. At least one of the pluralities of patch elements has a rectangular shape having a width and a height, the height being different from the width. At least two of the plurality of patch elements differ with respect to at least one of their respective widths and heights. Each patch element of the plurality of patch elements is configured with a common resonance frequency.

Among others, the inventors have found that patch elements arranged in an array structure become detuned with respect to a resonance frequency of the same patch element arranged in isolation. For example, a dual-polarized antenna patch having the same polarization frequencies for a first and second feed point becomes detuned and has different first and second polarization frequencies in a patch antenna array. This effect can be observed on all antenna patches arranged in the patch antenna array. However, the amount of detuning is different for each patch element within the array and different for each polarization direction or mode of the respective patch element, resulting in an uneven and uncontrolled behavior of the patch antenna array taken as a whole.

Among others, the inventors propose to address the above issues by controlling the resonance frequencies of all patch elements in the patch antenna array. In particular, the polarization frequencies of dual-polarized patch elements can be controlled by varying the width and height of each patch element, so that their polarization frequencies match with each other. Similarly, by modifying the respective widths and heights of patch elements arranged in proximity to each other, they can be tuned to the same resonance frequencies. Consequently, when starting from a matrix of equally sized square patch elements, one ends up with a matrix of patch elements of different dimensions, for example rectangular patches of different dimensions, but with the same resonance frequencies. As this is already considered at the design stage, no subsequent adjustment of the antenna, for example using external components to retune the patch elements, or by the provision of adapted feed signals during its operation, is required.

In at least one embodiment, each patch element of the array has two feed points and is configured as a dual-polarized and/or circular-polarized patch element. For a dual-polarized patch element, a first feed point is offset from a center of the patch element in a first direction, and a second feed point is offset from the center of the patch element in a perpendicular, second direction. For a circular-polarized patch element, a first feed point is arranged 90° out of phase with respect to a second feed point. For such dual or circular polarized patch elements, it is particularly advantageous if a resonance frequency in a first polarization direction, i.e., a first polarization frequency, matches a resonance frequency in a second polarization direction, i.e., a second polarization frequency.

In at least one alternative embodiment, each patch element of the array has one feed point and is configured as a single-polarized patch element, wherein the resonance frequency of each one of the single-polarized patch elements is the same. In this case, it may be advantageous to match the resonance frequencies of neighboring patch elements for applications such as angle measurements or beam forming, for example.

According to at least one embodiment, the widths and the height of each patch element differ from an average edge length of the patch element by more than 0.5%, in more than 1%, and/or less than 10%, in less than 5%. Such slight changes to the respective height and widths with respect to a corresponding square patch element having an equal edge length, e.g., an average edge length obtained by averaging the height and width of the rectangular patch element, is sufficient to compensate for the undesired detuning of individual patch elements. It is noted that such variations exceed typical manufacturing tolerances, which typically lie below 0.5%.

In at least one embodiment, an average edge length of each patch antenna is based on the common resonance frequency.

In at least one embodiment, the plurality of patch elements is arranged in a one-dimensional arrangement, in particular a horizontal row or vertical column, wherein each patch element is spaced apart from each neighboring patch element by a regular gap, provided, for example, in terms of a predefined center-to-center distance S. Such arrangements are advantageous, for example, for angle of arrival (AoA) or angle of departure (AoD) estimation, or beam forming in a specific direction.

In at least one embodiment, if the plurality of patch elements is arranged in a horizontal row, the width of each patch element may be the same. Alternatively, if the plurality of patch elements is arranged in a vertical column, the height of each patch element may be the same. Such a regular arrangement of patch elements simplifies manufacturing of one-dimensional patch antenna arrays.

In at least one embodiment of the above one-dimensional arrangements, the height of each patch element of the plurality of patch elements is larger than an average edge length of the plurality of patch elements and the width of each patch element of the plurality of patch elements is smaller than the average edge length, or the height of each patch element of the plurality of patch elements is smaller than the average edge length and the width of each patch element of the plurality of patch elements is larger than the average edge length. Put differently, each square patch element of a row or column of patch elements may be transformed into a rectangular shape by reducing one of its dimensions and, at the same time, increasing it in a second, perpendicular, dimension.

In at least one embodiment, the plurality of patch elements is arranged in a two-dimensional arrangement, in particular a matrix shape, an L-shape, a cross shape or a U-shape, wherein each patch element is spaced apart from each neighboring patch element by a regular gap, provided, for example, in terms of a predefined center-to-center distance S. Such arrangements are advantageous, for example, for AoA or AoD estimation, or beam forming in two different, perpendicular directions.

In at least one embodiment, at least one first patch element of the plurality of patch elements has the same width and height as a second patch element arranged at a symmetrically opposed position, in particular a mirror or point symmetric position, of the arrangement.

In at least one embodiment, a center-to-center distance S between each neighboring patch element is the same. In particular, the width of the center-to-center distance S may lie in the range between λ/4 and λ/2, wherein λ is the wavelength of an electromagnetic wave in air corresponding to the common resonance frequency. Such a center-to-center distance S is particularly relevant for applications such as antenna diversity transmission or spatial multiplexing, beam forming and AoA or AoD estimation and is relevant for detuning of individual patch elements.

According to at least one embodiment, one or more, in all, of the plurality of patch elements comprises a slot structure. For example, the slot structure may comprise a first and a second slot in a central area of the patch element, the first slot being perpendicular to the second slot, the first and the second slot extending an angle of 45° with respect to the edges of the rectangular shape of the respective patch element. Such slots are particularly useful for dual-polarized antennas and enable a reduction of the size for the respective patch elements.

According to a second aspect of the present disclosure, a method for manufacturing a patch antenna array, in particular the patch antenna array according to the first aspect or any of its implementations, is disclosed. The method comprises the steps of:
determining a desired resonance frequency;
determining a desired one- or two-dimensional arrangement of a plurality of patch elements on a common substrate; and,
starting with square patch elements having an edge length determined by the desired resonance frequency, varying the width and/or the height of at least one of the pluralities of patch elements, until a resonance frequency for at least one, preferably all, polarizations of each patch element correspond to the desired resonance frequency.

The above method steps enable the control of resonance or polarization frequencies of all patch elements of a patch antenna array. It changes the polarization dimension of each patch element to counteract its unwanted drift caused by interaction with a neighboring patch element.

The above method may be implemented, for example, based on computer simulations, but may also be based on experimental results by subsequently reducing or enlarging dimensions of individual patch elements and measuring their resonance frequencies experimentally.

Various embodiments of the present disclosure are described below with reference to the figures.

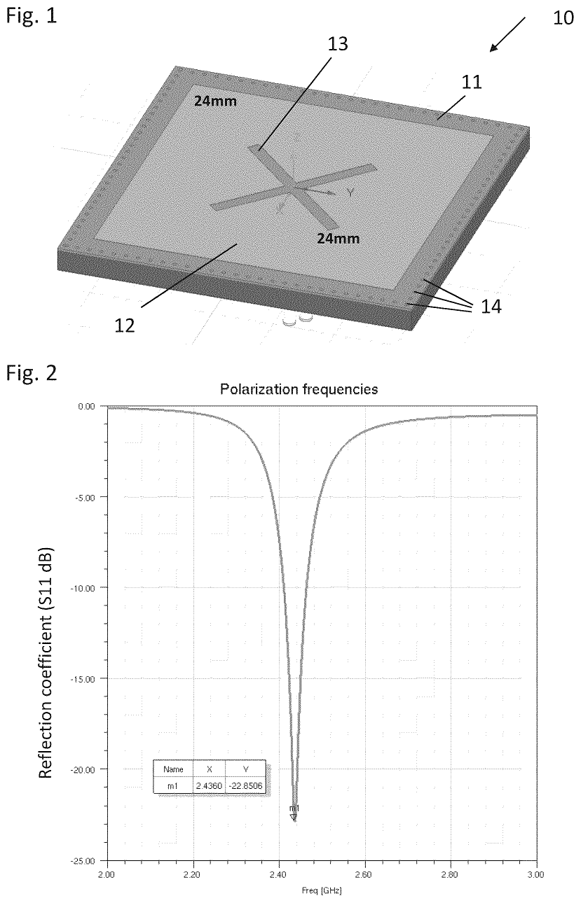

FIG. 1 shows a patch antenna comprising a single square patch element.

FIG. 2 shows horizontal and vertical resonance frequencies of the patch antenna of FIG. 1.

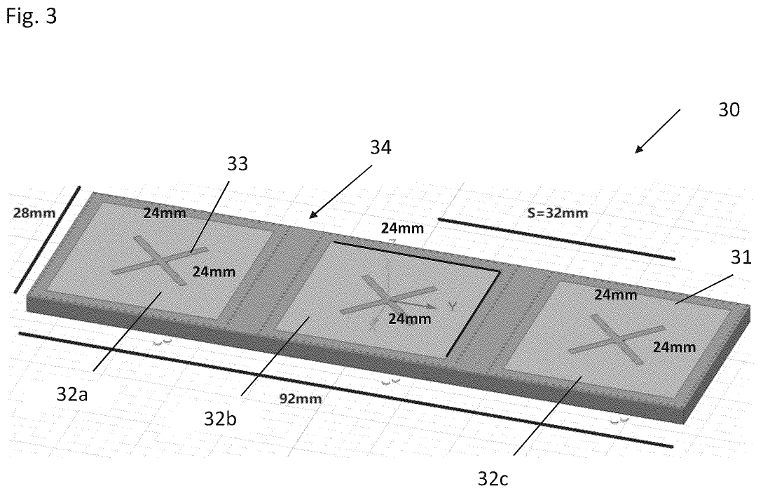

FIG. 3 shows a patch antenna array comprising a row of square patch elements.

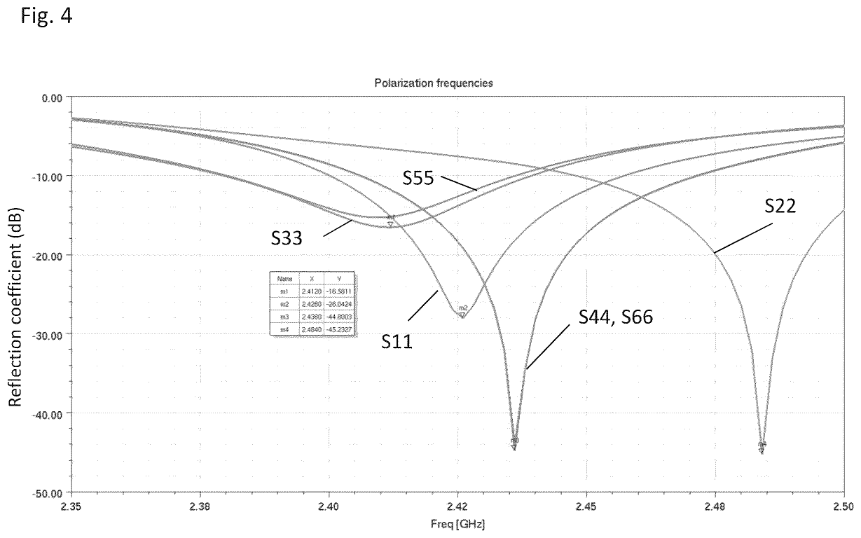

FIG. 4 shows resonance frequencies of the patch elements of the patch antenna array of FIG. 3.

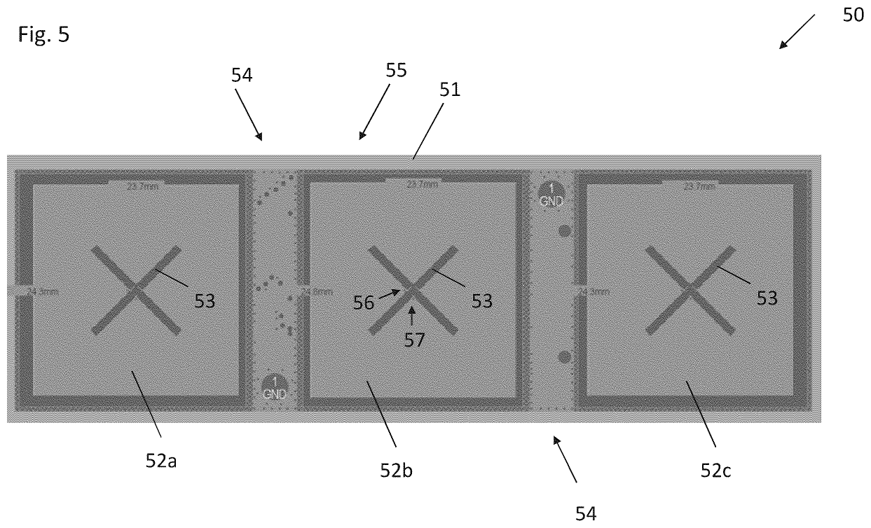

FIG. 5 shows a patch antenna array comprising three rectangular patch elements arranged in a row.

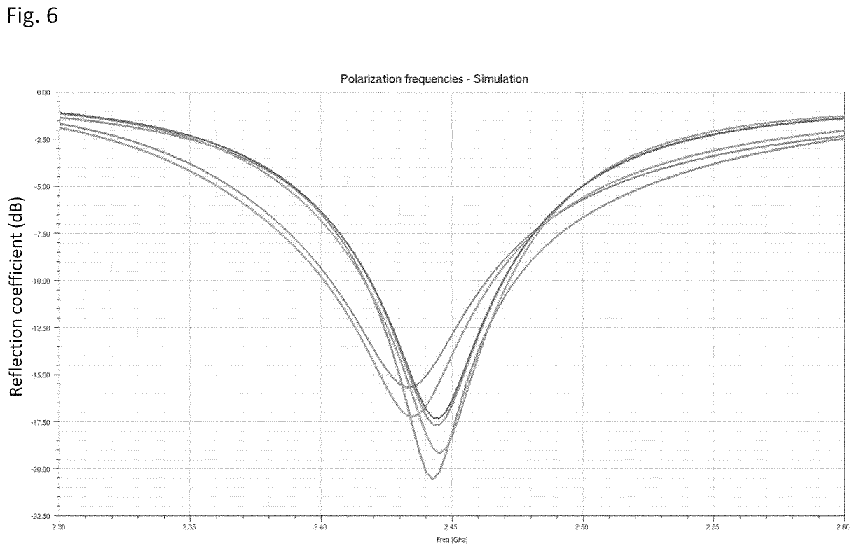

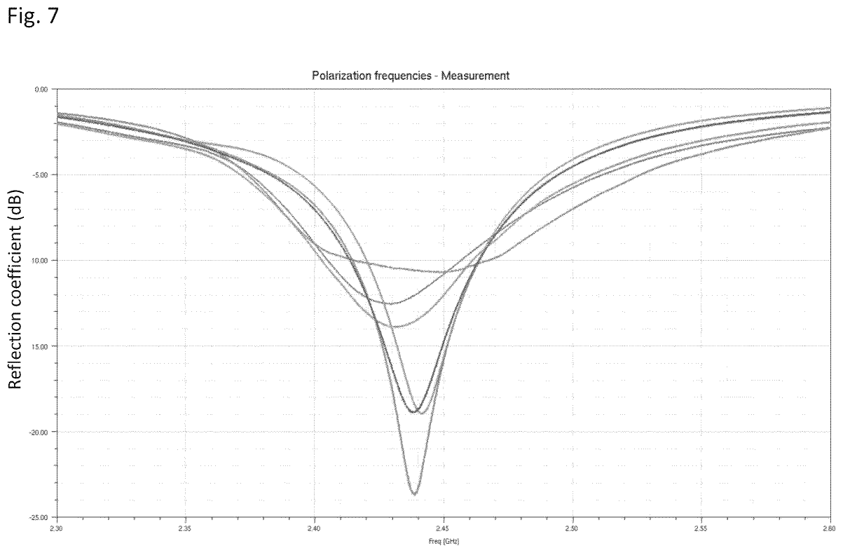

FIGS. 6 and 7 show simulated and measured resonance frequencies, respectively, of the patch elements of the patch antenna array of FIG. 5.

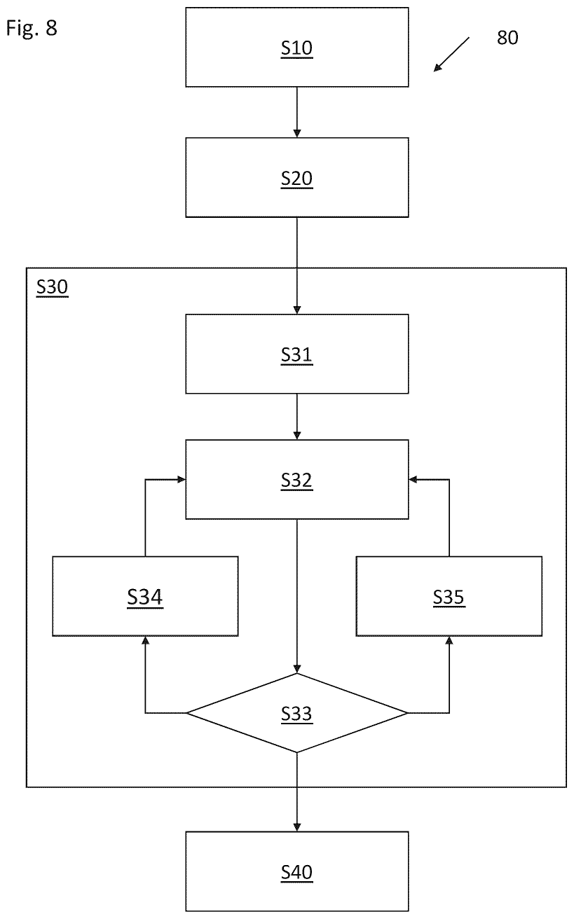

FIG. 8 shows steps of a method for manufacturing a patch antenna array.

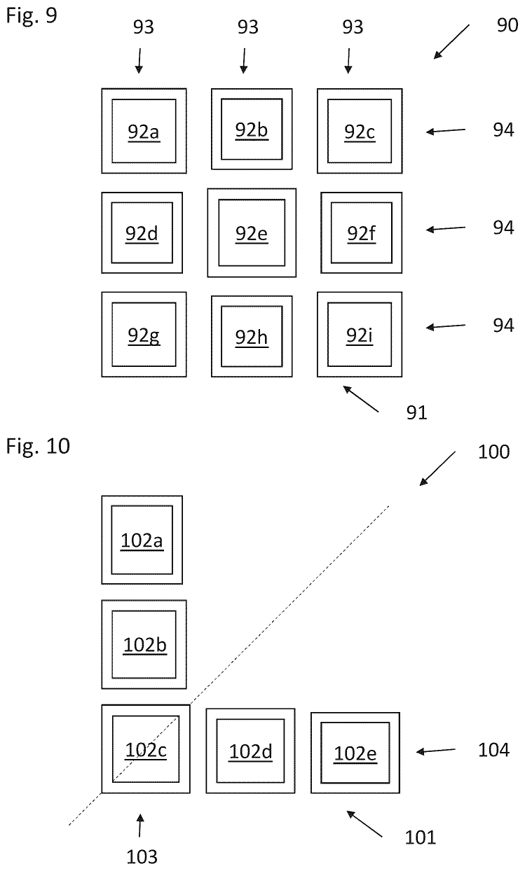

FIGS. 9 to 12 show different two-dimensional patch antenna array configurations having an array shape, an L-shape, a cross shape and a U-shape, respectively.

The specific configurations and dimensions of the patch antenna arrays shown in the figures and discussed below are provided for a better understanding of the disclosure and are not intended to limit the scope of the invention, which is set out in the attached set of claims.

For better understanding of the present disclosure, at first the properties of a patch antenna with a single patch element are described with respect to FIGS. 1 and 2.

As shown in FIG. 1, a patch antenna 10 comprises an insulating substrate 11 and a patch element 12 arranged on one of the main surfaces of the substrate 11. For example, patch element 12 may be formed directly on a PCB substrate, for example by etching a conductive copper layer arranged on an insulating layer of the PCB substrate. The patch element 12 has a square shape, i.e., its lengths and widths are the same. In the specific example shown in FIG. 1, its lengths and widths are 24 mm each. Although not visible in FIG. 1, a conductive ground plane is arranged on the opposite side of the substrate 11, i.e., its backside. The patch element 12 is surrounded by a plurality of further, dot-shaped ground elements 14.

A single square patch element 12 has the same polarization frequency in a vertical and horizontal direction. Thus, it may be used, for example, as a dual-polarized or circular polarized patch antenna. This can be achieved by providing respective RF signals at two separate feed points at distinct parts of the patch element (not shown in FIG. 1). In case of circular polarization, a copy of the RF signal provided to the first feed point is delayed by 90° degrees in phase and provided to the second feed point. A slot structure 13, as shown in FIG. 1, may be used to reduce the size of the patch antenna 10.

For easier reference, FIG. 1 also shows a coordinate system, which will be used throughout the specification. Accordingly, the height of the patch element 12 is measured in the x-direction, its width is measured in the y-direction and the thickness of the antenna 10 is measured in the z-direction of the indicated Cartesian coordinate system.

FIG. 2 shows the simulated resonance frequency for both the horizontal as well as the vertical polarization direction of the patch antenna 10 shown in FIG. 1. Due to the symmetric, square patch element 12, the two polarization frequencies coincide at a desired resonance frequency and are overlapping in FIG. 2. In the presented embodiment, the resonance frequency is 2.436 GHz. This frequency is useful, for example, for short-range RF communication, such as the Wi-Fi technology according to IEEE 802.11 family of protocols or the Bluetooth wireless technology according to IEEE 802.15.1.

FIG. 3 shows a patch antenna array 30 comprising three patch elements 32a, 32b and 32c arranged on a common substrate 31. On the backside of the substrate 31 a common ground plane (not visible in FIG. 3) is formed, covering the entire second main surface of the substrate 31. That is to say, the common ground plane forms the ground plane for all three of the patch elements 32a to 32c. As above, each patch element 32a to 32c is surrounded by a plurality of further, dot-shaped ground elements.

Each of the patch elements 32a to 32c comprises a slot structure 33, as mentioned before with respect to FIG. 1. Moreover, each of the patch elements 32a to 32c has a square shape with a common side length of, for example, 24 mm. As also indicated in FIG. 3, the substrate 31 has a total height of 28 mm and a total width of 92 mm. The center points of neighboring patch elements 32b and 32c are arranged in a common row and separated in the y-direction by a center-to-center distance S of 32 mm as shown. Accordingly, two gaps 34 are formed between the first patch element 32a and second patch element 32b, and between the second patch element 32b and the third patch element 32c.

FIG. 4 shows the resulting reflection coefficient in dB depending on the operating frequency for each one of the patch elements 32a to 32c. In particular, the parameter S11 refers to the horizontal polarization of patch element 32b, S22 to the vertical polarization of patch element 32b, S33 to the horizontal polarization of patch element 32c, S44 to the vertical polarization of patch element 32c, S55 to the horizontal polarization of patch element 32a, and S66 to the vertical polarization of patch element 32a. As can be seen in FIG. 4, the respective six resonance frequencies are spread over a frequency range of 2.412 GHz to 2.484 GHZ, with two of them having resonance peaks m1 close to each other at about 2.412 GHz and two further curves completely overlapping with a resonance peak m3 at 2.436 GHz. Attention is drawn to the fact that even the resonance peaks m2 and m4 of the central patch element 32b are offset from the desired resonance frequency of 2.44 GHZ.

It can be seen that, when one dual-polarized patch element 12 becomes part of a patch antenna array 30 of identically configured patch elements 32, each of dual-polarized patch antennas becomes detuned. The same happens to all patch antennas inside the antenna array 30. The amount of detuning is different for each patch element 32 and each polarization direction, resulting in an uneven and uncontrolled behavior of the patch antenna array 30 taken as a whole.

It is, in principle, possible to correct the resonance frequencies of the individual slot antennas using external components, such as resistors, capacitors and inductors connected to the respective feed points. However, this requires the use of additional components, either on the substrate 31 directly, or as part of an associated transmission circuit. Moreover, due to manufacturing tolerances of the external components used for tuning, further errors may be introduced. Accordingly, this requires a further verification step after connection of the additional components, which results in a more complex and expensive manufacturing process.

FIG. 5 provides an alternative approach to correcting an unwanted detuning. It shows an improved patch antenna array 50 having an asymmetrical patch antenna design. In the patch antenna array 50, the polarization frequencies of all patch elements 52a to 52c arranged on a common substrate 51 are controlled at a design stage. This is achieved by changing the polarization dimensions of each patch element 52a to 52c to counteract its unwanted frequency drift or detuning.

As shown in FIG. 5, the central patch element 52b has a width of 23.7 mm, i.e., about 1.25% less than the 24 mm edge length of the corresponding square patch element 32b, and a height of 24.8 mm, i.e., about 3.33% more than the 24 mm edge length of the corresponding square patch element 32b. The outer patch elements 52a and 52c each have a width of 23.7 mm and a height of 24.3 mm. That is to say, the array patch antenna is both point symmetric with respect to the center of the central patch element 52b and mirror symmetric with respect to the x- and y-axis through said central point. Moreover, attention is drawn to the fact that each of the three patch elements has the same width of 23.7 mm.

Accordingly, starting from an array of equally sized square patch elements 32a to 32c as shown in FIG. 3, one obtains an array 50 of rectangular patch elements 52a to 52c of different dimensions, but with the same polarization frequencies. Given a desired polarization frequency and overall arrangement of the patch antenna array, by e.g. the relative arrangement of the respective patch elements 52 and a center-to-center distance S between them, one should obtain a unique solution for the height and width of each of the patch elements 52a to 52c when all frequencies match at the desired polarization frequency. To limit the computational effort required for optimization at the design phase, an acceptable frequency windows may be defined, for example a frequency range centered at 2.440 GHz+/−10 MHz in the presented example.

The patch elements 52a to 52c are arranged in proximity to each other, i.e., close enough to cause electromagnetic interference or coupling. They may be separated by a center-to-center distance S defined by the intended wavelength. As the height and width of the patch elements 52a to 52c are also dependent on the intended wavelength, the width of the gaps 54 will typically be significantly smaller than the width or height of the individual patch elements 52a to 52c. For example, for a center-to-center distance of S=32.0 mm and a common width of the patch elements of 52a to 52c of 27.7 mm, the gaps have a width of 4.7 mm. Typically, for example for AoA estimation, a center-to-center distance S may lie in the range of λ/4 to λ/2, wherein λ is the wavelength of an electromagnetic wave in air corresponding to the radio carrier frequency and the common resonance frequency. For beam forming, the center-to-center distance S typically lies around λ/2, for example in a range of λ/2+/−20% or less, preferably λ/2+/−10% or less.

The patch antenna array 50 also comprises a ground plane 55 running the entire board size, which is arranged on the opposite back surface of the substrate 51 and is not visible in FIG. 5. Moreover, one can see that each of the patch elements 52 comprises a first feed point 56 and a second feed point 57 arranged in a center of each patch element 52, just left and below the central meeting point of two individual slots together forming a slot structure 53. These feed points 56 and 57 are connected within substrate 51, for example using internal vias of a multiplayer PCB, for connection with RF connectors at the bottom layer, which are also hidden in FIG. 55.

Attention is drawn to the fact that the slot structures 53 is optional in all embodiments. It may also affect the polarization frequencies of the patch elements 52a to 52c and may result in an overall more compact antenna design.

Attention is further drawn to the fact, that the above antenna design may also be employed for patch antenna arrays with circular polarization directions, i.e., a circular-polarized antenna, and/or a single, linear polarization direction, i.e., a linear-polarized antenna. For a circular-polarized antenna, the design of the patch antenna array 50 remains the same, wherein one of the signals provided to one of the two feed points 56 and 57 is 90 degrees out of phase with respect to the signal provided to the other feed point 57 or 56, respectively. For a linear-polarized antenna, the patch antenna array 50 with the single row of three horizontally arranged patch elements 52a to 52c as shown in FIG. 5 may be configured, for example, as a vertically polarized patch antenna array. In that case, only a single, vertical feed point 57 and/or feed signal may be provided. Inversely, if the patch antenna array 50 is configured as a horizontally polarized patch antenna array, only a single, horizontal feed point 56 or feed signal may be provided for each of the patch elements 52a to 52c. Although a single row of three horizontally arranged patch elements 52a to 52c is shown in FIG. 5, a single column of vertically arranged patch elements may also be used in either case.

FIGS. 6 and 7 show results of a simulation and of actual measurements performed for the patch antenna array 50 shown in FIG. 5, respectively. As can be seen in both instances, the corresponding six polarization frequencies of each of the three patch elements 52a to 52c and each of the two polarization directions lie within a narrow frequency band between 2.43 and 2.45 GHz, i.e., matches the desired frequency of 2.440 GHz+/−10 MHz. Accordingly, no external components are required for retuning the individual patch elements 52a to 52c to the desired resonance frequency. As a result, the verification time for the entire patch antenna array 50 can be shortened considerably.

For example, after fabrication, the test time can be reduced by 80% or more due to a significant reduction of manual work required for testing. The proposed design is also less prone to errors as no additional components need to be connected, which may lead to further faults or tolerances. Of course, the omission of external components also leads to a significant reduction in costs. In the case that the design of the patch antenna array changes, for example by adding further patch elements to the array, the optimization procedure can be repeated directly at the design stage, without further manual testing and retuning after manufacturing, for example, of prototypes.

Moreover, in the case that the rectangular patch elements 52a to 52c are smaller than the original square patch elements 32, the carrier substrate 51 and thus the final patch antenna array 50 may also be smaller as compared to the solution shown in FIG. 3. For example, in the specific example shown in FIG. 5, the total width is reduced by 2×0.3 mm, i.e., by 0.6 mm in total.

FIG. 8 shows the steps of a method 80 for manufacturing a patch antenna array, such as the patch antenna array 50 shown in FIG. 5.

In a step S10, a desired resonance frequency is determined. For example, the desired resonance frequency may be determined by a specific application, such as the transmission of electromagnetic radio waves at a desired frequency determined by a corresponding standard, e.g., 2.44 GHz.

In a step S20, a desired arrangement of a plurality of patch elements on a common substrate is determined. A one- or two-dimensional arrangement of patch elements may be determined depending on a specific transmission configuration used, for example, for AoA estimation, AoD estimation, beam forming and/or antenna diversity transmission. Step S20 may comprise, among others, the relative arrangement of the patch elements with respect to each other, i.e., their center-to-center distance and relative orientation of centers. The center-to-center distance S may be expressed as a fraction of the intended wavelength λ of an RF wave to be sent or received by the patch antenna array. For example, a center-to-center distance S in the range of λ/4 to λ/2 may be desirable. Moreover, other parameters, such as a material, thickness or total size of the substrate may also be defined in step S20 and considered in step S30 below.

In a step S30, at first an arrangement of a corresponding square patch elements is assumed and a corresponding resonance frequency for each patch element and, if applicable, polarization direction of each patch element, is determined. Thereafter, the width and/or the height of each patch element is varied until a resonance frequency for at least one, preferably all polarization directions, of each patch element corresponds to the desired resonance frequency.

Step S30 may be further broken down, as shown in FIG. 8, into a first sub-step S31, wherein the side length of each patch element of the patch antenna array under consideration is determined, and a sequence of optimization sub-steps S32 to S35.

For example, as a starting configuration in sub-step S31, the width and height of each patch element may correspond to the side lengths of a single, isolated patch element 12 having a resonance frequency determined for the desired wavelength 2.

In the relatively simple case of a square patch element without the above mentioned slot structure, and ignoring further effects caused by vias around the patch element as well as the thickness of the substrate, an initial edge length L, i.e. the height and widths of each patch element, may be set to

$$L \approx 0.49 λ = 0.49 \frac{{λ}_{0}}{\sqrt{ε}} ,$$

where λ₀ is the electro-magnetic wavelength at the common resonance frequency in free space, and ε is the dielectric constant of the substrate. In presence of the above elements, i.e., the slot structure 54, vias and a thick substrate, the above equation no longer holds. In particular, the initial edge length L may be reduced by up to 15% compared to the formula for L above. However, as the impact of these factors is complex and not independent from each other, a rough estimation of the initial edge length L based on the wavelength may be used, followed by a computer-based optimization procedure as detailed below.

In sub-step S32, corresponding polarization frequencies are determined for each patch element. Sub-step S32 may be performed using computer simulations or, alternatively, using measurements on corresponding prototypes.

Then, in a sub-step S33, it is verified whether the polarization frequencies determined in sub-step S32 fall within a desired target range, for example, a frequency band with a given bandwidth, e.g., 5, 10 or 20 MHZ, and centered at the desired resonance frequency determined in step S10.

If this is not the case, the width, the length, or both of one or several of the patch elements is varied in corresponding sub-steps S34 and S35, respectively. The process is repeated from step S32 until the verification succeeds in step S33, or, alternatively, if a predetermined number of optimization rounds have been performed.

If verification succeeds in step S33, step S30 is completed and, in a subsequent step S40, the current configuration of the patch antenna array and each of its patch elements is output, for example, to produce a corresponding mask layer for production.

FIGS. 9 to 12 show further configurations of patch antenna arrays 90, 100, 110 and 120, respectively. Contrary to the one-dimensional, horizontal row of patch elements 52a to 52c shown in FIG. 5, and a corresponding vertical arrangement of patch elements in a vertical row (not shown), each one of FIGS. 9 to 12 shows a two-dimensional arrangement of patch elements. Although not shown in detail, each of the patch antenna arrays 90, 100, 110 and 120 is configured similarly to the patch antenna array 50 described above. For example, each of the patch antenna arrays 90, 100, 110 and 120 will contain a substrate and common ground plane. Moreover, their respective patch elements 92, 102, 112 and 122 are configured similarly as the patch elements 52 described above.

Specifically, FIG. 9 shows a matrix shape 91 of a total of nine patch elements 92a to 92i. The patch elements 92 are arranged in three columns 93 and three rows 94 each. FIG. 9 shows the special case of a square 3×3 matrix. Accordingly, the patch elements 92a to 92i of the patch antenna array 90 have only four different configurations. The central patch element 92e has a first configuration, i.e., a specific length and height, the four corner elements 92a, 92c, 92g and 92i have a second configuration, the left and right patch elements 92d and 92f have a third configuration, and the remaining upper and lower patch elements 92b and 92h have a fourth configuration. Due to the symmetry of the arrangement, the third and fourth configurations are similar, wherein the respective length and widths are swapped. Note that in this symmetric configuration, the central patch element 92e will typically have a square shape, i.e., have the same length and height. In this case, the edge length of the square patch element patch element 92e may be above or below the average edge length of all patch elements 92a to 92i. Specific dimensions of the patch elements 92a to 92i are determined, for example, using the method 80 shown in FIG. 8. In general, an M×N matrix shape may have M horizontal rows and N vertical columns, with M>1 and N>1.

FIG. 10 shows a patch antenna array 100 having an L-shape 101. The L-shape 101 comprises a single column 103 and a single row 104 of three patch elements 102 each. In the specific example, the lowermost patch element 102c of the column 103 forms the leftmost patch element 102c of the row 104. Each one of the patch elements 102a to 102e of FIG. 10 has one of five different configurations. However, due to the mirror symmetry through the x=y-axis through the central point of patch element 102c (see dashed line), the height and width of path element 102a correspond to the width and height of path element 102e, respectively. Similarly, the height and width of path element 102b correspond to the width and height of path element 102d, respectively. Like the above, the joint patch element 102c will typically have a square shape configuration. In general, an MxN L-shape may have one horizontal row with M patch elements and one vertical column with N patch elements joined at one of their respective ends, with M>1 and N>1.

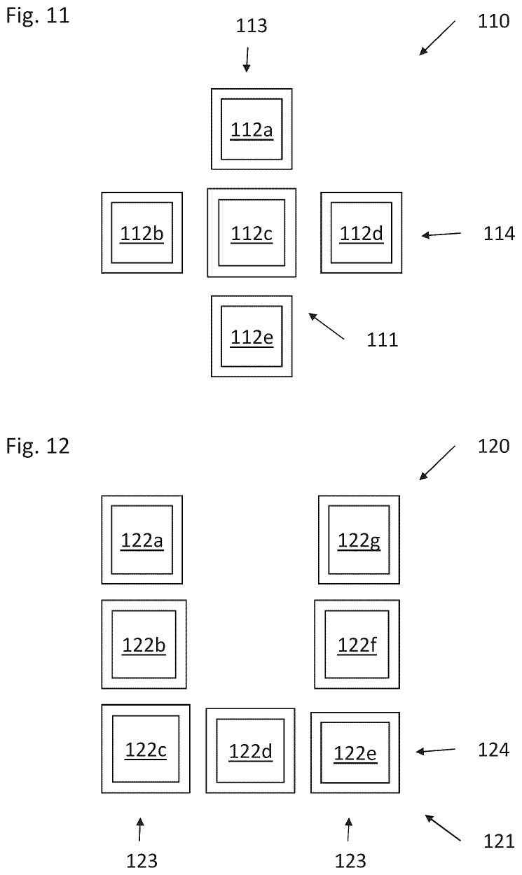

FIG. 11 shows a patch antenna array 110 with a cross shape 111. As shown therein, a single column 113 is crossing a single row 114 at their respective central patch element 112c. In this case, three types of patch elements exist, the central patch element 112c, the vertically extending patch elements 112a and 112e and the horizontally extending patch elements 112b and 112d. Due to the symmetry of the arrangement, the configuration of the vertically extending patch elements 112a and 112e corresponds to the configuration of the horizontal extending patch elements 112b and 112d wherein the respective length and widths are swapped. Note that in this symmetric configuration, the central patch element 112c will typically have a square shape. Like FIG. 9 above, the edge length of the square patch element patch element 112c may be either above or below the average edge length of all patch elements 112a to 112e. In general, an MxN cross shape may have one horizontal row with M patch elements and one vertical column with N patch elements sharing one arbitrary patch element, preferably an inner or central patch element, with M>1 and N>1.

It is noted that the specific configurations shown in FIGS. 9 to 11 show a variety of configurations that can be varied and or combined with one another. As one example, individual patch elements could be added or removed from each row or column, such that the resulting shape is no longer symmetric. For another example, as shown in FIG. 12, a patch antenna array 120 with a U-shape 121 can be obtained by partially overlapping two L-shapes 101 as shown in FIG. 10.

In general, any two- or three-dimensional arrangement of patch antenna array is possible and envisioned by the inventors. For example, it is not necessary that each of the patch elements is arranged in a regular grid pattern. Instead, it is also possible to arrange patch elements of one row or one column at locations corresponding to gaps of another row or column. Thus, for example, a triangular overall shape of the patch antenna array may be obtained (not shown). The more complex the relative arrangement, the more useful it becomes to determine and verify the configuration of each patch element using computer simulations.

The above description has focused on the arrangement, configuration, and computation of patch antenna arrays for dual-polarized patch antennas. However, it is noted that the disclosed method 80 as well as the asymmetric design as shown in FIGS. 5 and 9 to 12 can equally be applied to single-polarized patch antennas, a single polarization frequency or circular-polarized antennas, wherein the provided feed signals are replicas of each other and are provided with a phase angle of 90° difference. Accordingly, it is not intended to limit the scope of the present disclosure to dual-polarized patch antenna arrays in general, or the specific embodiments shown in the attached drawings and described above. Instead, the protective scope is to be determined by the attached set of claims.

### LIST OF REFERENCES

10 patch antenna
11 substrate
12 patch element
13 slot structure
14 ground element
30 patch antenna array
31 substrate
32 patch element
33 slot structure
34 gap
50 patch antenna array
51 substrate
52 patch element
53 slot structure
54 gap
55 ground plane
56 first feed point
57 second feed point
80 manufacturing method
90 patch antenna array
91 matrix shape
92 patch element
93 column
94 row
100 patch antenna array
101 L-shape
102 patch element
103 column
104 row
110 patch antenna array
111 cross shape
112 patch element
113 column
114 row
120 patch antenna array
121 U-shape
122 patch element
123 column
124 row
S10-S40 method steps

1. A patch antenna array, comprising:
a substrate;
a ground plane arranged on a first surface of the substrate; and
a plurality of patch elements arranged in proximity to each other on an opposite, second surface of the substrate;
wherein:
at least one of the plurality of patch elements has a rectangular shape having a width and a height, the height being different from the width;
at least two of the plurality of patch elements differ with respect to at least one of their respective widths and heights; and
each patch element of the plurality of patch elements is configured with a common resonance frequency.

2. The patch antenna array of claim 1, wherein each patch element of the array has two feed points and is configured as at least one of a dual-polarized or circular-polarized patch element, wherein:
for a dual-polarized patch element, a first one of the feed points is offset from a center of the patch element in a first direction, and a second one of the feed points is offset from the center of the patch element in a perpendicular, second direction;
for a circular-polarized patch element, the first one of the feed points is arranged 90° out of phase with respect to the second one of the feed points.

3. The patch antenna array of claim 2, wherein each patch element has two polarization frequencies as follows:
a horizontal polarization frequency and a vertical polarization frequency for a dual-polarized patch element, or
at least one of a clockwise polarization frequency or a counterclockwise polarization frequency for a circular polarized patch element,
wherein all polarization frequencies of each one of the patch elements are essentially the same.

4. The patch antenna array of claim 1, wherein each patch element of the patch antenna array has one feed point and is configured as a single-polarized patch element, and the resonance frequency of each one of the single-polarized patch elements is essentially the same.

5. The patch antenna array of claim 1, wherein the width and the height of each patch element differs from an average edge length of the patch element by more than 0.5% and less than 10%.

6. The patch antenna array of claim 1, wherein an average edge length of each patch element is based on the common resonance frequency.

7. The patch antenna array of claim 1, wherein the plurality of patch elements is arranged in a one-dimensional arrangement, wherein each patch element is spaced apart from each neighboring patch element by a regular gap based on a predefined center-to-center distance S.

8. The patch antenna array of claim 7, wherein
the plurality of patch elements is arranged in a horizontal row, and the width of each patch element is essentially the same.

9. The patch antenna array of claim 7, wherein;
the height of each patch element of the plurality of patch elements is larger than an average edge length of the plurality of patch elements, and the width of each patch element the plurality of patch elements is smaller than the average edge length; or
the height of the each patch element the plurality of patch elements is smaller than the average edge length and the width of each patch element the plurality of patch elements is larger than the average edge length.

10. The patch antenna array of claim 1, wherein the plurality of patch elements is arranged in a two-dimensional arrangement, wherein the two-dimensional shape is a matrix shape, an L-shape, a cross shape or a U-shape, and wherein each patch element is spaced apart from each neighboring patch element by a regular gap based on a predefined center-to-center distance S.

11. The patch antenna array of claim 7, wherein at least one first patch element of the plurality of patch elements (52) has the same width and height as a second patch element arranged at a mirror or point symmetric position of the arrangement.

12. The patch antenna array of claim 7, wherein the center-to-center distance S between each neighboring patch elements is essentially the same, and wherein the center-to-center distance S lies in the range between λ/4 and λ/2, wherein λ is the wavelength of an electromagnetic wave in air corresponding to the common resonance frequency.

13. The patch antenna array of claim 1, wherein one or more of the plurality of patch elements comprise a slot structure.

14. The patch antenna array of claim 13, wherein the slot structure comprises a first and a second slot in a central area of the patch element, the first slot being perpendicular to the second slot, the first slot and the second slot extending at an angle of 45° with respect to the edges of the rectangular shape of the respective patch element.

15. A method for manufacturing a patch antenna array, the method comprising:
determining a particular resonance frequency;
determining a particular one- or two-dimensional arrangement of a plurality of patch elements on a common substrate; and
starting with square patch elements having an edge length determined by the resonance frequency, varying at least one of the width or the height of at least one of the plurality of patch elements until a resonance frequency for at least one polarization frequency of each patch element corresponds to the particular resonance frequency.

16. The patch antenna array of claim 7, wherein the plurality of patch elements is arranged in a horizontal row or a vertical column.

17. The patch antenna array of claim 7, wherein the plurality of patch elements is arranged in a vertical column, and the height of each patch element is essentially the same.
